(19) United States
(12) Patent Application Publication
(10) Pub. No.: US 2019/0133111 A1
(43) Pub. Date: May 9, 2019

(54) METHOD AND DEVICE FOR MONITORING THE TEMPERATURE OF A CRYOPRESERVED BIOLOGICAL SAMPLE

(71) Applicant: Fraunhofer-Gesellschaft zur Foerderung der angewandten Forschung e. V., Muenchen (DE)

(72) Inventors: Guenter R. FUHR, Berlin (DE); Heiko ZIMMERMANN, Waldbrunn (DE)

(21) Appl. No.: 16/095,936

(22) PCT Filed: Mar. 31, 2017
(86) PCT No.: PCT/EP2017/000405

§ 371 Date: Oct. 23, 2018

(30) Foreign Application Priority Data
Apr. 27, 2016 (DE) 10 2016 005 076.4

(51) Int. Cl. A01N 1/02; G01K 11/06

(52) U.S. Cl. CPC A01N 1/0268; G01K 2203/00; G01K 11/06; A01N 1/0252

(57) ABSTRACT

The invention relates to a device for monitoring the temperature of a cryopreserved biological sample, comprising a sample container (1) having a receiving space (2) for receiving a biological sample (6) and a cover (3) for closing the receiving space. The device also comprises a chamber arranged inside the sample container, in particular in the receiving space and/or in the cover, the interior (12; 22; 32; 42) of which is not fluidically connected to the receiving space (2) and is only partially filled with at least one indicator substance (7) having a melting temperature in the region between −20° C. and −140 ° C. The invention also relates to a method for monitoring the temperature of cryopreserved samples, comprising the following steps: providing a device (10; 20; 30; 40) for 12b temperature monitoring; freezing the indicator sub stance/s, wherein the at least one chamber can be placed in a first position during the freezing of the indicator substance/s and in a second position after the freezing and when a temperature of the indicator substance/s is below the melting temperature, in which position a melting of the indicator substance/s leads to an at least partial shift and/or change in shape of the chamber filling, with the influence of the force of gravity.

The invention relates to a method for temperature monitoring of a cryopreserved biological sample. The invention further relates to a device for temperature monitoring of a cryopreserved biological sample.

The low-temperature preservation (cryopreservation) of cells is hitherto the only possibility of stopping vital processes reversibly (maintaining vitality) at a cellular level such that they can restart after heating to physiological temperatures. Cryopreservation has developed by way of large biobanks in recent decades to become an essential element for clinics, pharmaceutical companies, species survival, environmental protection and health provision. Biological material is stored in low-temperature-compatible sample containers (cryogenic containers), e.g. tubes, straws and bags, of various sizes. In the case of cryopreservation, the stored biomaterial is frozen while maintaining the vitality of the sample material, usually at temperatures below −80° C., for living collections below −140° C. to the temperature of liquid nitrogen. The term “cryogenic sample” is also used below for a cryopreserved sample or a sample intended for cryopreservation.

Numerous techniques have been developed for macroscopic samples, such as e.g. blood or tissue, for sample storage at low temperatures. There is a tendency in modern medicine, genetic engineering and biology to increasingly subject small samples to cryopreservation. For example, small suspension volumes (milliliter or below) with suspended cells or groups of cells are frozen. The cryopreservation of cells from in-vitro cultures is primarily carried out in a suspension. However, the majority of biomedically significant cells require a substrate contact for their propagation and proper development. Samples are therefore frozen in the substrate-bound state possibly after cultivation.

The quality of the samples is of decisive importance since they are used for cell therapies in clinics, the development of pharmaceuticals and biotechnological products, as national resources and many other things. The storage time varies from a few days up to decades, with a tendency towards long-term storage. The samples are stored in cooled containers, are usually located in metal drawers and racks, with which they are subjected to temperature fluctuations in the case of new deposits or removals. In the case of living storage (cells, cell suspensions and pieces of tissue), it is not only the uninterrupted cooling chain which plays a vital role, but also the avoidance of large jumps in temperature in the deep-freezing phase. Since it is not unknown during removal for cryogenic containers to heat up to temperatures of −80° C. to −20° C., despite the fact they are still frozen, reductions in quality unknowingly arise which not only reduce the value of the sample, but can also lead to life-threatening situations when they are used in the clinical sector. Even if samples have only thawed briefly, it is not possible to see in the refrozen state that they no longer match the original condition. However, it is especially important to not only identify a thawing of the biomaterial, but also to document the exceeding of a threshold temperature in the range between −140° C. and −20° C. Temperature control and documentation for each sample is the requirement, one which has hitherto only seldom been satisfied, and if so, with high technical outlay. One must also remember extensive laboratory tests after thawing which also use valuable sample material and generate costs even in the case of cryogenic samples which have become worthless in the interim.

One object of the invention is thus to provide an improved method for temperature monitoring of a cryopreserved biological sample, with which disadvantages of conventional techniques can be avoided and which is characterized by a simplified execution of the method. A further object is to provide a device for temperature monitoring of a cryopreserved biological sample with which disadvantages of conventional techniques can be avoided.

A further object is to provide a possibility in order to be able to identify from as simple as possible a marker whether a cryogenic sample has been heated above a definable threshold temperature, even if only for a short time. It must be possible to fix the threshold temperature in the range between −20° C. and −140° C. prior to freezing. This should be possible quickly and in a readily apparent manner at each individual cryogenic sample and at thus millions of samples, must not change the biomaterials and should already be carried out in the deep-frozen state. If possible it should be possible to detect the condition of the sample even in the storage container since every time the sample is removed from and returned to storage there is the risk of a change in sample of a plurality of samples in the store since entire racks are generally pulled up. The device and the method should be easy to handle, low-temperature-tolerant and adjustable. It must consume no or only a small amount of energy and result in only the smallest of costs since the storage of a biological sample in the cooled state should only cost a few Euros in terms of total outlay. The materials used must also satisfy this requirement.

These objects are achieved by devices and methods with the features of the independent claims. Advantageous embodiments and applications of the invention will become apparent from the dependent claims and are explained in greater detail in the following description with partial reference to the figures.

According to a first aspect of the invention, the stated objects are achieved by a method for temperature monitoring of a cryopreserved biological sample. A device for temperature monitoring of a cryopreserved biological sample is provided to carry out the method.

According to a second aspect of the invention, the device for temperature monitoring of a cryopreserved biological sample should be disclosed and capable of being claimed as the subject matter per se. The embodiments relating to the device, in particular its advantageous embodiment variants, should thus, in order to avoid repetition, be regarded as disclosed as device features in connection with the device and as device features in connection with and according to the method and capable of being claimed as such.

The device for temperature monitoring of a cryopreserved biological sample comprises a sample container with a receiving space (sample reservoir) for receiving a sample, in particular a biological sample. The receiving cavity can contain a cryopreserved biological sample.

The device further comprises a chamber, the inner space of which is not fluidically connected to the receiving space. The inner space is furthermore filled only partially with at least one indicator substance, wherein the melting temperature at normal pressure, i.e. at 1013.25 mbar, of the indicator substance lies in a range from −20° C. to −140° C.

An additional compartment which may be used as an indicator element or indicator device as a result of partial filling with the indicator substance is provided by the chamber of the device according to the invention in order to display an undesired exceeding of the threshold temperature. The chamber which is partially filled with indicator substance is therefore also referred to below as the indicator device.

According to one particularly preferred embodiment, the chamber is arranged in the interior of the sample container, in particular in the receiving space and/or in the cover. The arrangement in the interior of the sample container has the particular advantage that no additional installation space is required outside the sample container. The chamber may, however, also be arranged on the outside of the sample container or be integrated into a wall of the receiving space.

The sample container is a container which is suitable for cryopreservation, for example, a tube, a straw (also referred to as a seed tube), a bag for blood or stem cell storage, a box or another container which is suitable for cryopreservation. Such containers are correspondingly also referred to as cryogenic tubes, cryogenic straws, cryogenic bags, cryogenic boxes or generally as cryogenic containers.

According to one particularly preferred embodiment, the sample container is a cryogenic tube. Cryogenic tubes are also referred to as biobank or cryobank tubes. Cryogenic tubes have a receiving space which forms an inner cavity for receiving a biological sample. The cryogenic tube furthermore normally has a cover for closing off the receiving space. The cover can have an engagement via which the cover may be rotated with a tool. The cryogenic tube can also have a base element which has a marking, e.g. in the form of machine-readable code.

The method further comprises freezing the indicator substance, wherein the chamber for freezing the indicator substance is moved into a first position so that the indicator substance in the liquid state flows into a first partial volume of the chamber and freezes there. Thereafter, in particular before and during the monitoring phase of cryogenic storage, the chamber with the frozen indicator substance is moved into a second position in which melting of the indicator substance, as a result of the influence of gravity, leads to a change in configuration of the chamber filling. The change in configuration may be an at least partial displacement of the chamber filling and/or a change in the shape of the chamber filling. The chamber filling may be formed by the indicator substance or by the indicator substance and by one or more solid bodies which are arranged in the chamber and have a higher density than the indicator substance.

In other words, the indicator substance is frozen in such a geometry or position and the chamber is changed in its position in the deep-frozen state, e.g. at the storage temperature or at least below the fixed threshold temperature or melting temperature of the indicator substance, so that melting of the indicator substance leads, after the change in position, to a visible displacement of the liquid or its delimiting geometry or to a displacement of the solid bodies which are arranged in the chamber and which, after melting of the indicator substance, are no longer frozen solid therein.

On the basis of this change in configuration of the chamber filling, it is possible to immediately determine by visual inspection or also in a technically automated manner whether the threshold temperature was exceeded.

According to the method, it is thus possible to store the device, having the sample container with a cryogenically preserved sample and the at least one chamber with the frozen indicator substance, for cryopreservation, wherein the at least one chamber for temperature monitoring is arranged in the second position on the sample container.

At a later point in time, it is possible to check and determine whether a change in configuration of the chamber filling triggered by exceeding the melting temperature of the indicator substance has taken place, e.g. whether an at least partial displacement and/or change in form of the chamber filling has taken place.

If this is the case, it can be concluded that the melting temperature of the indicator substance and thus the threshold temperature to be monitored have been exceeded, in particular even if the exceeding has only taken place for a short time.

One particular advantage of the invention thus lies in the fact that a change in configuration of the chamber filling, e.g. the indicator substance, directly shows whether a cryogenic sample has heated up over a definable threshold temperature, even if only for a short time.

This can be determined by visual inspection or also in a technically automated manner by means of a correspondingly configured measuring apparatus without the sample having to be removed from the sample container or thawed out.

According to one particularly preferred embodiment, the inner space of the chamber is divided into several sub-spaces which are separated from one another and which are filled in each case only partially with an indicator substance, the melting temperature of which lies in a range from −20° C. to −140° C., wherein the indicator substances in the sub-spaces have different melting temperatures. Different temperature threshold values can thus be monitored, wherein each indicator substance is selected and/or its mixture ratio is adjusted so that its melting point corresponds to one of the temperature threshold values to be monitored. This embodiment has the advantage that the achieved temperature intervals which the sample has reached can be more precisely restricted.

Moreover, the sample container and a chamber wall at at least one point can be transparent or semi-transparent so that it is visible from outside as to whether a change in configuration, e.g. a change in position, of the indicator substance has taken place. The entire wall of the sample container and the chamber is preferably embodied to be transparent or semi-transparent.

For the purpose of improved detectability, the indicator substance can contain an indicator additive which improves detectability of a physical property of the indicator substance. The indicator additive can be, for example, a dye so that the indicator substance is colored or dyed, i.e. not transparent, and thus its shape and/or location is optically better apparent.

In principle, any dye which satisfies at least the following conditions is possible as a dye:
intensive dyeing capacity even in small quantities and concentrations (e.g. starting from a saturated dye solution addition in the range <1% by volume, generally in the parts-per thousand or sub-parts-per-thousand range).
frost-tolerant
lightfast at the dispatch temperatures and also the relevant low temperatures
soluble in all components of the indicator substance
no separation during freezing
no reaction with plastic materials which come into contact with the indicator substance.

The dye is preferably selected from the group which comprises triphenylmethane dyes, rhodamine dyes, in particular xanthene, azo dyes as well as phenazine and phenothiazine dyes.

In more specific embodiments, the dye is selected from the group which comprises oil red, methyl red, brilliant green, rhodamine B, neutral red, methylene blue or other dyes which are used to dye cells in cytology.

The indicator additive can be particles, in particular nanoparticles which increase a scattering action and/or polarization action of the indicator substance for electromagnetic radiation striking the indicator substance. As a result, a change in configuration of the indicator substance may be detected more reliably by means of optical transmission measurement, scattering measurement and/or polarization measurement. The indicator additive may be conductive particles. The conductivity or impedance of the indicator substance may be influenced by adding conductive particles. In this manner, a change in configuration of the indicator substance may be detected by means of a conductivity measurement or impedance measurement.

According to one preferred embodiment, the device may have a measuring apparatus which is formed to detect a configuration state of the chamber filling, e.g. a location of the indicator substance in the chamber. The measuring apparatus may be an optical or optical-electric measuring apparatus in order to determine a change in configuration of the indicator substance e.g. with an optical transmission, scattered light or reflection measurement.

A substance, the melting temperature of which corresponds to a predetermined threshold temperature, the exceeding of which should be monitored, may be selected as the indicator substance. The indicator substance is a liquid or a mixture of different liquids, the melting point of which corresponds to the desired threshold temperature. Merely by way of example, a mixture of water (H₂O) and ethanol (C₂H₆O), a mixture of water (H₂O) and potassium hydroxide (KOH) or a mixture of water and an antifreeze can be selected as the indicator substance. The mixture ratio is adjusted according to the respective melting diagram which indicates the profile of the melting point as a function of the mixture ratio so that the melting point of the liquid mixture has the desired value, namely the threshold temperature to be monitored.

According to one preferred embodiment, the indicator substance comprises at least one alcohol which is selected from the group which comprises octan-1-ol, nonan-1-ol, propane-1,2-diol, propane-1,3-diol, butane-1,2-diol, butane-1,3-diol, butan-2-ol, pentane-1,5-diol, pentan-1-ol, cyclopentanol, benzyl alcohol. The at least one alcohol is particularly preferably selected from propane-1,3-diol, propane-1,2-diol and butan-2-ol.

According to another preferred embodiment, the indicator substance comprises at least two different alcohol components:

a) an alcohol selected from the group which comprises octan-1-ol, nonan-1-ol, propane-1,2-diol, propane-1,3-diol, butane-1,2-diol, butane-1,3 -di ol, butan-2-ol, pentane-1,5-diol, pentan-1-ol, cyclopentanol, benzyl alcohol;
b) an alcohol selected from the group which comprises octan-1-ol, nonan-1-ol, propane-1,2-diol, propane-1,3-diol, butane-1,2-diol, butane-1,3 -diol, butan-2-ol, pentane-1,5-diol, pentan-1-ol, cyclopentanol, benzyl alcohol with a lower melting point than the alcohol of component a);
wherein the mixing ratio of components a) and b) is adjusted so that the melting temperature of the mixture lies within a temperature range from −20° C. to −160° C., in particular from −25° C. to −160° C. or −50° C. to −150° C.

More specific embodiments are characterized in that the indicator substance comprises one of the following combinations of components a) and b):
octan-1-ol and butan-2-ol in a mixture ratio of 5% to 95% by volume;
octan-1-ol and pentan-1-ol in a mixture ratio of 5% to 95% by volume;
octan-1-ol and propane-1,2-diol in a mixture ratio of 5% to 95% by volume;
nonan-1-ol and butan-2-ol in a mixture ratio of 5% to 95% by volume;
nonan-1-ol and propane-1,2-diol in a mixture ratio of 5% to 95% by volume;
nonan-1-ol and pentan-1-ol in a mixture ratio of 5% to 95% by volume;
propane-1,2-diol and butan-2-ol in a mixture ratio of 5% to 95% by volume;
propane-1,2-diol and propane-1,3-diol in a mixture ratio of 5% to 95% by volume;
propane-1,2-diol and butane-1,2-diol in a mixture ratio of 5% to 95% by volume;
propane-1,3-diol and butan-2-ol in a mixture ratio of 5% to 95% by volume;
propane-1,3-diol and butane-1,2-diol in a mixture ratio of 5% to 95% by volume;
pentane-1,5-diol and butan-2-ol in a mixture ratio of 5% to 95% by volume;
benzyl alcohol and butan-2-ol in a mixture ratio of 5% to 95% by volume;
pentan-1-ol and butan-2-ol in a mixture ratio of 5% to 95% by volume;
pentan-1-ol and methanol in a mixture ratio of 5% to 95% by volume;
cyclopentanol and butan-2-ol in a mixture ratio of 5% to 95% by volume;
cyclopentanol and propane-1,2-diol in a mixture ratio of 5% to 95% by volume;
cyclopentanol and pentan-1-ol in a mixture ratio of 5% to 95% by volume;
cyclopentanol and butane-1,2-diol in a mixture ratio of 5% to 95% by volume; wherein the indicated value of the mixture ratio relates in each case to the ratio of the former component in the mixture of both components.

According to particularly preferred embodiments, this indicator mixture comprises, for example, propane-1,2-diol and butan-2-ol in a mixture ratio of 40% to 60% by volume (produces a melting temperature of approx. −90° C.), propane-1,2-diol and propane-1,3-diol in a mixture ratio of 30% to 70% by volume, or propane-1,3-diol and butan-2-ol in a mixture ratio of 30% to 70% by volume.

The indicator substance preferably also comprises, in addition to the at least one alcohol, at least one dye as described above. This dye is particularly preferably selected from the group which comprises oil red, methyl red, brilliant green and rhodamine B.

An even more specific embodiment is characterized in that the indicator substance comprises two alcohols a) and b), which are selected from propane-1,3-diol, propane-1,2-diol and butan-2-ol, preferably in a mixture ratio as indicated above, as well as a dye which is selected from the group which consists of oil red, methyl red, brilliant green and rhodamine B.

The concentration of the dye in the alcohol component can vary greatly depending on the dye and alcohol.

In the case of intensive coloring, the concentration should generally be kept as low as possible so that the dye molecules do not change the freezing and melting properties of the alcohols in which they are dissolved or increase their viscosity. The dye concentration typically lies in a range of <10% by volume, in particular <1% or <0.1%, i.e. in the percent or parts per thousand or sub-parts per thousand range.

In one variant of the present invention, the threshold temperature to be monitored does not correspond directly to the melting temperature of the indicator substance, but rather that temperature above the melting temperature at which the viscosity of the melted substance has reduced to such an extent that the required liquid transport can take place.

This temperature is also referred to here as the threshold temperature and typically lies in a temperature range of 3-30° C. or 5-30° C., for example, 3-10° C., 3-20° C., 5-10° C. or 5-20° C., above the nominal melting temperature.

According to one advantageous embodiment, the indicator substance is therefore characterized in that the liquid mixture in a temperature range of 3-30° C. or 5-30° C. above the melting temperature has a viscosity in a range from 10 to 10⁶ mPa*s, preferably 10 to 10⁴ mPa*s.

The sample container may have a cover which is provided to close off the receiving space. The cover may have a shaft which is in engagement with an upper end region of the receiving space. The shaft may be formed onto a head part of the cover so that, in the placed-on or screwed-on state of the cover, the head part sits on the receiving space, while the shaft engages in an upper end region of the receiving space.

According to one particularly preferred embodiment, the chamber may be integrated into the cover, e.g. into the head part and/or the shaft. This has the advantage that the incorporated indicator apparatus cannot contaminate a biological sample stored in the receiving space since it does not come into contact with it, but rather is enclosed in a cover which is to be used in any event. A further advantage is that the chamber which serves as an indicator apparatus can be stored and prepared (e.g. freezing the indicator substance in the first position) together with the cover in a manner which is spatially separate from the rest of the sample container. An integration of the chamber into the shaft of the cover is particularly advantageous. According to this variant, the shaft of the cover has a cavity which is partially filled with indicator substance. Particularly in the case of cryogenic tubes, often only a lower sub-volume of the receiving space is filled with the biological sample so that an upper sub-volume may be used for the arrangement of the indicator sub stance.

According to a further preferred embodiment, the chamber is embodied as a closed hollow body which is arranged in the receiving space of the sample container below the cover.

This variant has the advantage that a conventional cryogenic container may be used.

In the case of this embodiment, the closed hollow body may be arranged loosely on a cryopreserved biological sample present in the receiving space, e.g. placed on it.

One possibility of the realization according to the invention provides that at least one solid body which has a higher density than the indicator substance is arranged loosely in the inner space of the chamber. The solid body may be a metal body. The loose arrangement should mean that the at least one body is placed in the inner space of the chamber and is in principle freely movable there, at least in the liquid state of the indicator liquid, unless it is frozen solid by the indicator substance.

According to one variant, only one solid body, the volume of which is greater than that of the indicator substance, may be arranged loosely in the chamber. According to a further variant, at least two solid bodies can be present in the inner space of the chamber, wherein a volume of the solid bodies is in each case smaller than a volume of the indicator substance.

These arrangements have the advantage that even liquids with a melting point below −100° C., further preferably far below −100° C., may be used which then usually have a very high viscosity. The indicator substance would then not flow on the wall to the base of the chamber, but rather remain in an upper part of the chamber. The weighty body/bodies arranged loosely in the chamber in contrast falls/fall out of the liquid onto the base. This may be detected e.g. by an expediently embodied measuring apparatus, e.g. an optical sensor, a sensor for measuring conductivity, etc. A visual determination of the state is also possible.

The term sample container refers in particular to a container configured for cryopreservation. The sample container is preferably produced using low-temperature-compatible plastic material for temperatures below −140° C. The plastic material can tolerate repeated temperature changes without change and without damage. A plastic material is preferably used, the water absorbing capacity of which is <1% of the net mass, in particular <0.1% of the net mass. Cryogenic storage elements according to the invention are based, for example, on polyurethane or polyethylene.

The term “biological sample” refers to biological material such as cells, tissue, cell components, biological macromolecules, etc. which are subjected to cryopreservation in the sample container, where applicable, in a suspension and/or in combination with a substrate material. A substrate which is configured for adherent receiving of biological cells which are part of the biological sample may thus be arranged in the receiving space.

The preferred embodiments and features of the invention described above can be combined with one another. Further details and advantages of the invention are described below with reference to the enclosed drawings. In the drawings:

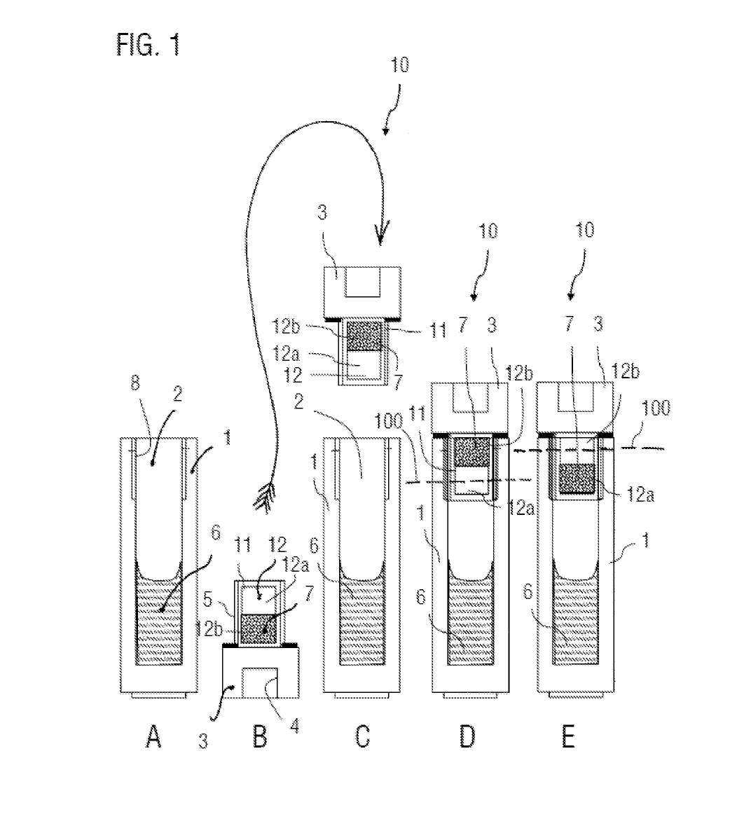

FIGS. 1-4 show schematic views of various exemplary embodiments of a device for temperature monitoring of a cryopreserved biological sample;

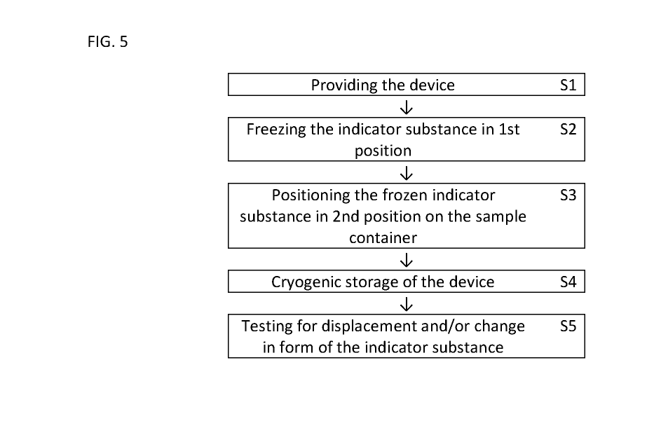

FIG. 5 shows a flow chart to illustrate an exemplary embodiment of a method for temperature monitoring of a cryopreserved biological sample;

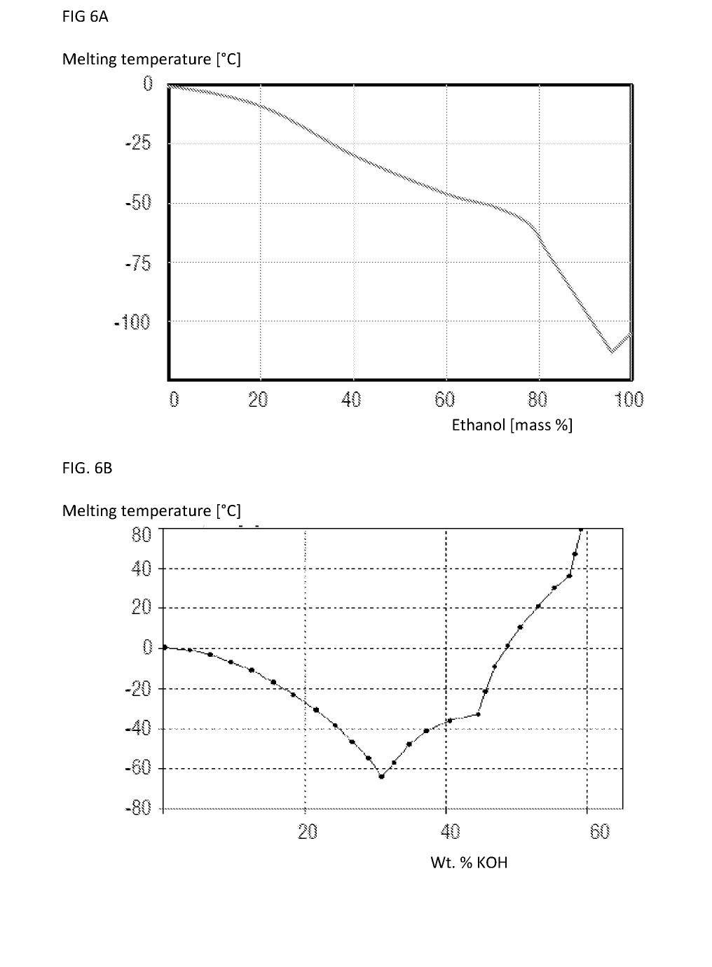

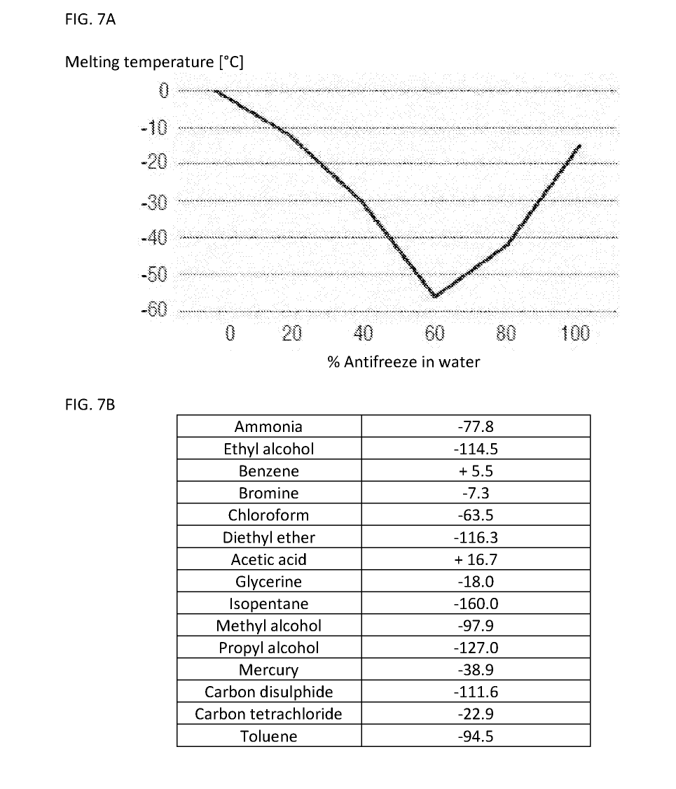

FIGS. 6A, 6B, 7A show in each case a melting diagram of a liquid mixture;

FIG. 7B shows a table with melting points of a number of pure liquids; and

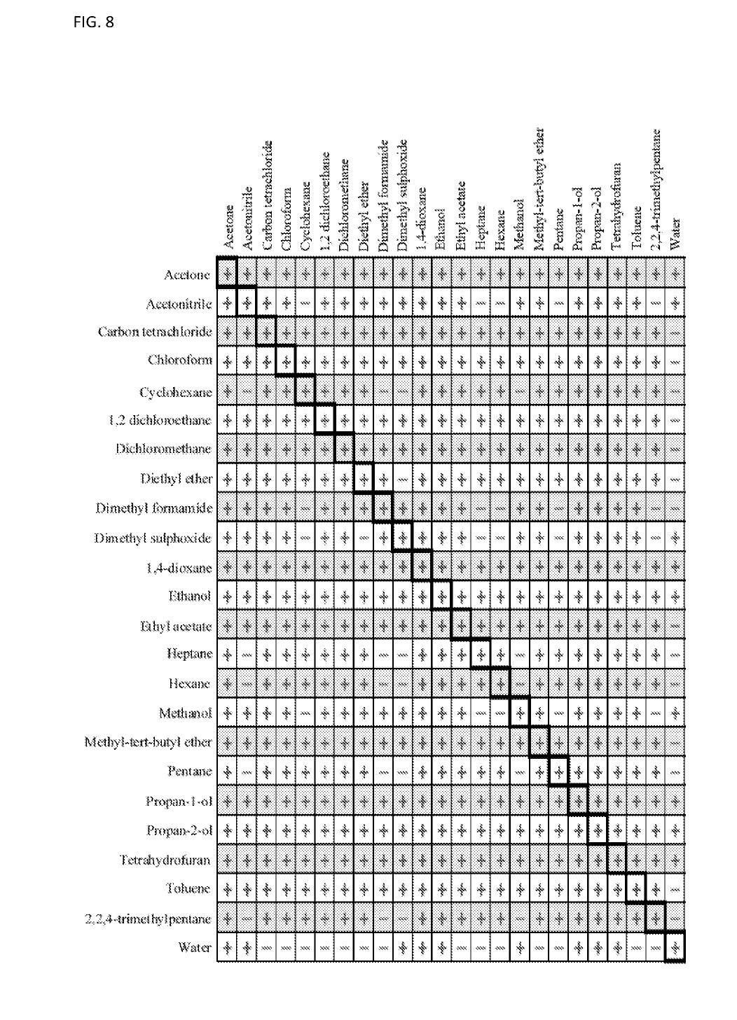

FIG. 8 shows a mixability matrix of solvents.

Identical elements or functionally equivalent elements are designated by the same reference numbers in all the figures and are partially not described separately.

Schematic sectional views A to E of FIG. 1 illustrate a first exemplary embodiment of the invention.

In this case, in FIG. 1A, a cylindrical receiving part 1 of a cryogenic tube is represented in section. Receiving cavity 2 formed by cylindrical receiving part 1 has already been filled here with biological sample 6. Biological sample 6 may be e.g. a cell suspension. In FIG. 1B, cover 3 which can be screwed on via a thread 8 for cryogenic tube 1, 3 is shown, which cover 3 is upside down, closes off receiving part 1 and optionally possesses at the top an engagement 4 via which cover 3 can be rotated with a tool (not shown) in the case of automation. The cover contains, in the screw-in part, i.e. in shaft 5, which engages in receiving volume 2 in the screwed state, a chamber 11 which forms a hollow volume 12. This is partially filled with an indicator substance 7 in the form of a liquid or a liquid mixture, the freezing point/melting point of which is selected in the range from −20° C. to −100° C. via the mixture ratio so that the melting point has the value of a temperature threshold to be monitored. This is also explained in greater detail below on the basis of FIGS. 5 to 8.

For storing such a biological sample 6, cryogenic tube 1 is deep-frozen to the storage temperature in the open state, as shown in FIG. 1A, and cover 3 in the upside-down position, as shown in FIG. 1B. Indicator substance 7 initially collects in the liquid state under the influence of gravity in sub-volume 12b of hollow volume 12 of chamber 11 and freezes there during cooling to the storage temperature or to a temperature which lies at least below the melting temperature of indicator substance 7.

At the storage temperature, at least, however, below the melting temperature of indicator substance 7, screw-on cover 3 is rotated by 180° and screwed in as in FIG. 1C and FIG. 1D in order to close off cylindrical receiving part 1 shown in FIG. 1A. Indicator substance 7 which is frozen solid in sub-volume 12b remains in upper sub-volume 12b of the chamber. Lower sub-volume 12a is substantially free of indicator substance 7.

Device 10 formed in this manner for temperature monitoring can thus be cryogenically stored. In this form, usually standing perpendicular in receptacles, device 10 is stored in the low-temperature containers.

If biological sample 6 is now brought above the melting point of indicator substance 7 in the event of any manipulation or damage situation in the storage tank, this becomes liquid, drips downwards, and the image represented in FIG. 1E is produced. If, however, the sample has been stored correctly, the indicator substance is still located in sub-region 12a of chamber 11 after a storage process. The state is represented in FIG. 1D. In this manner, inadmissible heating of sample 6 is easily apparent. The position of the indicator substance within chamber 11 may be optically detected by visual inspection. In the case of a transparent or semi-transparent embodiment of cryogenic tube 1, 3, the position of indicator substance 7 may also be determined in an automated visual manner via a horizontal detection, represented schematically by dashed line 100.

A further advantage of device 10 is the reusability of cover 11 and the use of marker liquids used as indicator substance 7 with a freely selectable freezing point. For living racks, a melting temperature around −80° C. is recommended since here a clear recrystallization of the ice in the cells and around these occurs which leads to a reduction in quality of the cryogenic sample. For biological liquids and storage of genetic material which is stored at −80° C., a melting point around −30° C. is to be recommended.

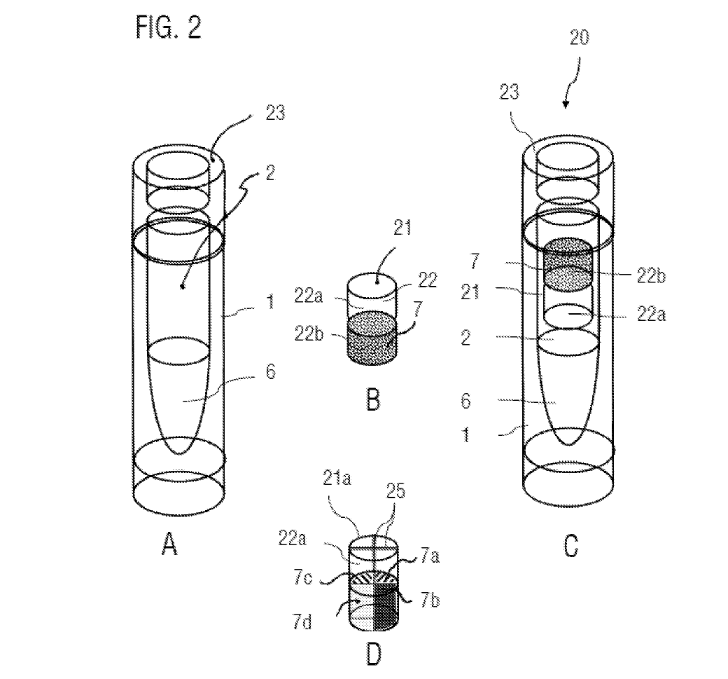

FIG. 2 shows a further exemplary embodiment of a device 20 for temperature monitoring of a cryopreserved biological sample. Device 20 in turn comprises a cryogenic tube as a sample container and an indicator apparatus 21 which can be arranged in the interior of the cryogenic tube in the form of a hollow cylinder form 21 or 21a which is filled partially with indicator substance 7.

FIG. 2A shows a cryogenic tube which can also, for example, be deep frozen. The cryogenic tube in turn comprises a cylindrical receiving part 1 which forms a receiving cavity 2 which has already been filled here with biological sample 6. The cryogenic tube further comprises a cover 3 for the cryogenic tube which closes off receiving part 1.

A closed hollow cylinder 21 which is partially filled with an indicator substance 7 and in this manner may be used as an indicator apparatus for temperature monitoring is used for future detection of the exceeding of a critical threshold temperature. Indicator substance 7 is again selected so that its melting point lies in the range from −20° C. to −100° C. and has the value of a temperature threshold to be monitored.

Hollow cylinder 21 is frozen in the position shown in FIG. 1B outside the cryogenic tube. The indicator substance collects in lower sub-volume 22b and freezes solid there.

Cryogenic tube 1, 23 shown in FIG. 1A is subsequently opened in that cover 23 is screwed off, hollow cylinder 21 is placed, rotated by 180°, onto already frozen biological sample 6 and cryogenic tube 1, 23 is closed again so that the image represented in FIG. 1C is produced. Hollow cylinder 21 thus lies loosely on the biological sample, in an alignment in which the indicator substance is initially located in the frozen state at the top in cavity 22.

If the melting temperature of indicator substance 7 was subsequently reached, the liquid is once again located at the base of cylinder 21, in sub-volume 21a, from which it is apparent that a critical threshold temperature was exceeded.

A four-chamber hollow cylinder 21a which can be used in an analogous manner instead of hollow cylinder 21 and inserted in the same manner into a cryogenic tube 1, 23 is alternatively represented in FIG. 2D. In this case, the inner space of hollow cylinder 21 is divided by separating walls 25 into four fluidically separate sub-cavities which are filled in each case partially with an indicator substance. Indicator substances 7a, 7b, 7c, 7d in the sub-cavities are, however, different and have different melting points.

A graduation of the melting points of indicator substances 7a, 7b, 7c, 7d is expediently selected, e.g. −20° C. for indicator substance 7a, −50° C. for indicator substance 7b, −80° C. for indicator substance 7c and −110° C. for indicator substance 7d.

If, during an inspection, frozen indicator substances 7a to 7c are still located in upper region 22b of the hollow cylinder, but indicator substance 7d is still located at the base (sub-region 22a), a temperature of −110° C. would be exceeded in the case of sample 6. If indicator substance 7c is also located at the base, if −80° C. was exceeded, if all marker liquids 7a to 7d were located at the base, even −20° C. has been exceeded.

Hollow cylinder 21 or 21a incorporated in receiving space 2 should be sterile on its surface or otherwise made germ-free and contamination-free.

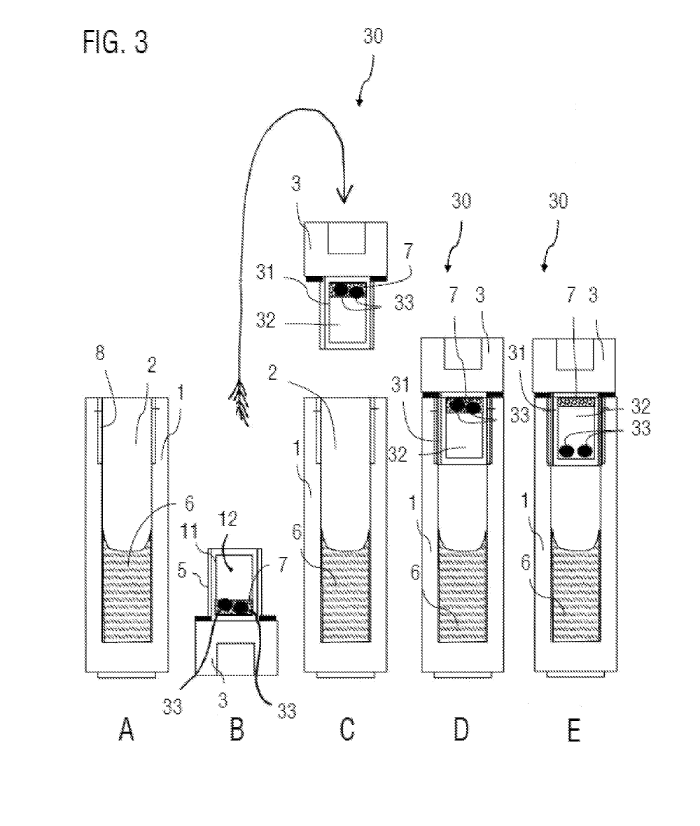

FIG. 3 shows a further exemplary embodiment of a device 30 for temperature monitoring of a cryopreserved biological sample. The particular feature of this device 30 in comparison with device 10 shown in FIG. 1 lies in the fact that chamber 31 integrated into cover 3 of the cryogenic tube is not only partially filled with an indicator substance 7, rather further contains small solid bodies 33 which are incorporated loosely in the inner space or cavity 32 of chamber 33.

FIG. 3A thus shows receiving part 1 of a cryogenic tube in section in an analogous manner to FIG. 1A. The chamber integrated into shaft 5 of upside-down cover 3 is, as shown in FIG. 3B, only filled at the base with an indicator substance 7. Small bodies 33 with comparatively higher density than the indicator substance and thus higher weight are located in this chamber. Bodies 33 may be, for example, metal balls. Receiving part 1 and upside-down cover 3 are now brought to the storage temperature. As a result of this, small bodies 33 freeze in indicator liquid 7. If the cover is now screwed on rotated by 180° as in FIG. 1, as represented in FIG. 3C, the chamber filling, comprising frozen indicator substance 7 with fixed small bodies 33, is then located at the top of cavity 32 of chamber 31.

If the melting temperature of indicator substance 7 is not exceeded during cryogenic storage, an image as shown in FIG. 3D is produced. The configuration of the chamber filling has not changed, both indicator substance 7 and small bodies 33 frozen solid therein are located at the top of cavity 32 of chamber 31.

If the melting temperature of indicator substance 7 is exceeded, at least weighted bodies 33 fall to the base of cavity 32 of chamber 31, as represented in FIG. 3E. This arrangement has the advantage that even liquids with a melting point far below −100° C. can be used which then usually possess a very high viscosity. Indicator substance 7 would then not flow on the wall to the base of cavity 32, but rather remain in the upper part. In contrast, weighted bodies 33 fall out of liquefied indicator substance 7 onto the base, as shown in FIG. 3E. This may be detected e.g. by a sensor (conductivity, optically, etc.). A visual determination of the state is also possible.

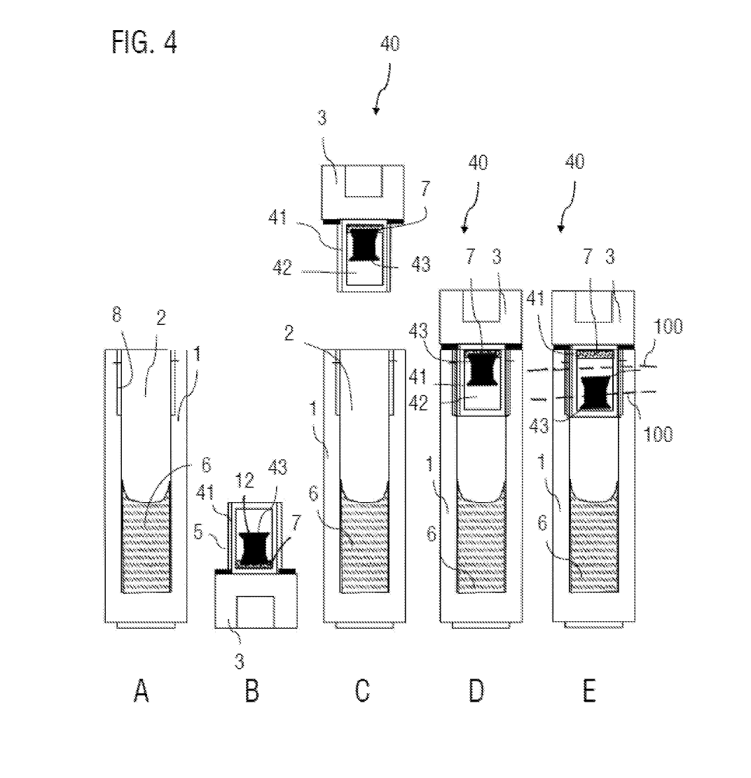

FIG. 4 shows a further exemplary embodiment of a device 40 for temperature monitoring of a cryopreserved biological sample. The particular feature of this device 40 in comparison with device 30 shown in FIG. 3 lies in the fact that, instead of several small bodies, a comparatively large and heavy body 43 is located in chamber 41 integrated into cover 3 next to the indicator substance.

FIG. 4A again shows receiving part 1 of a cryogenic tube for a biological sample 6 in section. FIG. 4B again shows an upside-down cover 3 of the cryogenic tube, in the interior of which a chamber 41 is again integrated which forms a cavity 42 which is partially filled with an indicator substance 7. Moreover, a larger and heavy body 43 is further incorporated loosely into cavity 42. The freezing of the indicator substance and storing of device 40 are performed in an analogous manner to that for device 30. In an analogous manner to the device shown in FIG. 3, here, the detachment of large body 43 is even less susceptible to faults in the event of the exceeding of the melting temperature of indicator substance 7, it simultaneously releases an optically transparent section or blocks it as a result of its sinking. The optically transparent section is represented schematically by dashed line 100 in FIG. 4E.

FIG. 5 illustrates on the basis of a flow chart a method for temperature monitoring of a cryopreserved biological sample. In step S1, a device for temperature monitoring is provided, for example, one of devices 10, 20, 30, 30 or 40. In this case, depending on the temperature threshold value which is supposed to be monitored in the case of cryogenic storage, a suitable liquid or a liquid mixture is to be selected as indicator substance 7.

Via the selection of suitable liquids and the mixture ratio of liquids, their melting point may be set to a desired value, in particular in a range from −20° C. to −140° C.

By way of example, FIG. 6A indicates the profile of the melting point as a function of the mixture ratio of an alcohol and water, with which, in the case of a moderate increase in viscosity with falling temperature, a temperature range between 0° C. and −118° C. may be covered. Should e.g. a temperature threshold value of −118° C. be monitored, the ethanol ratio may be set at 93.5%. Melting points up to a value of slightly below −60° C. can also be set by adding potassium hydroxide (KOH) to water, which is shown in FIG. 6B on the basis of a melting diagram. A mixture of water and antifreeze can also be used as the indicator substance, which is illustrated by the melting diagram of FIG. 7A. The table of FIG. 7B lists freezing points/melting points of further pure liquids which can be used on their own or as a mixture with another liquid as the indicator substance. Further liquid mixtures which are suitable as the indicator substance include chloroform/cyclohexane mixtures or other mixable liquids which can be inferred e.g. from the mixability matrix of solvents of FIG. 8.

Liquids and plastic materials with good wettability and low viscosity at low temperatures are primarily selected in order to configure the change in position to be as extensive as possible and the additional compartment as small as possible.

If several temperature threshold values are supposed to be monitored during cryogenic storage or if the achieved temperature intervals which the sample reaches should be restricted more precisely, several different indicator substances with different melting points can correspondingly be used which are then arranged in different sub-cavities of the chamber.

In step S2, the indicator substance in the chamber is then frozen, wherein the chamber is moved into a first position during freezing of the indicator substance. In the case of different indicator substances and several chambers, these are moved in an analogous manner in each case into the first position and frozen. The first position corresponds in the case of the exemplary embodiments of FIGS. 1, 3 and 4 respectively to a position of cover 3, in the case of which it stands on its head, as is represented in FIG. 1B, 3B or 4B.

Thereafter, in step S3, the at least one chamber with the frozen indicator substance is moved into a second position and arranged inside the sample container. According to the exemplary embodiments shown in FIGS. 1 to 4, the second position is rotated by 180° with respect to the first position. According to the exemplary embodiments shown in FIGS. 1, 3 and 4, the chamber is moved into the second position by screwing cover 3 to receiving part 1. In the case of the embodiment variant of FIG. 2, the hollow cylinder is placed in receiving space 2 in a manner rotated by 180° with respect to frozen biological sample 6.

In this state, the device may be stored with a cryosample in the receiving space of the sample container in the case of a storage temperature below the melting temperature (step S4).

It is subsequently possible to check by examining the state of the chamber filling at any desired point in time during the storage process whether an undesirable, if only temporary heating of the cryosample has taken place (step S5). To this end, a check is made as to whether an at least partial displacement and/or change in form of the chamber filling caused by a melting process has taken place, as explained above in the case of FIGS. 1 to 4. If this is the case, an exceeding of the threshold temperature(s) to be monitored can be concluded.

Although the invention has been described with reference to specific exemplary embodiments, it is apparent for a person skilled in the art that various changes can be made and equivalents can be used as a replacement without departing from the scope of the invention. The invention should consequently not be restricted to the disclosed exemplary embodiments, but rather should encompass all the exemplary embodiments which fall into the scope of the enclosed claims. In particular, the invention also claims protection for the subject matter and the features of the subordinate claims independently of the claims referred to.

1. A device for temperature monitoring of a cryoserved biological sample, comprising
a) a sample container, having a receiving spaced for receiving a biological sample, and a cover for closing off the receiving space; and
b) a chamber arranged in an interior of the sample container, in particular in the receiving space and/or in the cover, wherein an inner space of the chamber is not fluidically connected to the receiving space and is only partially filled with at least one indicator substance, the melting temperature of which lies in a range from −20° C. to −140° C.

2. The device according to claim 1, wherein the sample container is a cryogenic tube.

3. The device according to claim 1, wherein the inner space of the chamber is divided into several sub-spaces which are separated from one another and which arc filled in each case only partially with an indicator substance, the melting temperature of which lies in a range from −20° C. to −140° C., wherein the indicator substances in the sub-spaces have different melting temperatures.

4. The device according to claim 1, wherein
a) the cover has a shaft which is in engagement with an upper end region of the receiving spaced and
b) the chamber is integrated into the shafts.

5. The device according to claim 1, wherein the chamber is a closed hollow body which is arranged in the receiving spaced of the sample container below the cover.

6. The device according to claim 5, wherein the closed hollow body is arranged loosely on a cryoserved biological sample present in the receiving space.

7. The device according to claim 1, wherein at least one solid body which has a higher density than the indicator substance is arranged loosely in the inner space of the chamber.

8. The device according to claim 7, wherein the melting temperature of the indicator substance lies below −100° C.

9. The device according to claim 7, wherein a solid body, a volume of which is greater than that of the indicator substance, is arranged loosely in the chamber.

10. The device according to claim 7, wherein
a) at least two solid bodies are present in the inner space; and
b) a volume of the solid bodies is in each case smaller than a volume of the indicator substance.

11. The device according to claim 1, wherein
a) a chamber wall at at least one point is transparent or semi-transparent, and/or
b) the indicator substance is colored.

12. The device according to claim 1, further comprising an optical, electric or optoelectric measuring device which is formed to detect a position of the indicator substance and/or the solid body in the chamber

13. A method for temperature monitoring of cryopreserved samples, comprising the steps:
a) providing a device for temperature monitoring according to claim 1;
b) freezing the at least one indicator substance, wherein the at least one chamber is moved into a first position during freezing of the at least one indicator substance and, after freezing and at a temperature of the at least one indicator substance below the melting temperature, is moved into a second position in which a melting of the at least one indicator substance leads, as a result of an influence of gravity, to an at least partial displacement and or change in shape of the chamber filling.

14. The method according to claim 13, wherein a substance is selected as the indicator substance, the melting temperature of which or the threshold temperature of which, at which a viscosity of the melted indicator substance exceeds a determined setpoint value, corresponds to a predetermined threshold temperature, an exceeding of which is monitored.

15. The method according to claim 13, further comprising
a) storing of a cryopreserved sample in the sample container, and
b) determining whether an at least partial displacement and/or change in shape of the chamber filling performed by temporarily exceeding the melting temperature of the indicator substance has taken place.

16. The device according to claim 1, wherein the indicator substance comprises at least one alcohol selected from the group consisting of octan-1-ol, nonan-1-ol, propane-1,2-diol, propane-1,3-diol, butane-1,2-diol, butane-1,3-diol, butane-2-ol, pentane-1,5-diol, pentan-1-ol, cyclopentanol, and benzyl alcohol as well as optionally at least one dye.

17. The device according to claim 16, the dye is selected from the group consisting of triphenylmethane dyes, rhodamine dyes, azo dyes, phenazine dyes and phenothiazine dyes.

18. The device according to claim 16, wherein the indicator substance comprises at least two alcohol components which are selected from the group consisting of octan-1-ol, nonan-1-ol, propane-1,2-diol, propane-1,3-diol, butane-1,2-diol, butane-1,3-diol, butane-2-ol, pentane-1,5-diol, pentan-1-ol, cyclopentanol, and benzyl alcohol and/or the indicator substance comprises at least one dye selected from the group consisting of oil red, methyl red, brilliant green, rhodamine B, neutral red, and methylene blue.
